(19) United States
(12) Patent Application Publication
(10) Pub. No.: US 2022/0088806 A1
(43) Pub. Date: Mar. 24, 2022

(54) KITCHEN KNIFE AND BLADE

(71) Applicant: NGK SPARK PLUG CO., LTD., Nagoya-shi, Aichi (JP)

(72) Inventors: Yusuke KATSU, Nagoya-shi (JP); Kuniharu TANAKA, Nagoya-shi (JP); Takeshi MITSUOKA, Nagoya-shi (JP)

(21) Appl. No.: 17/422,480

(22) PCT Filed: Jul. 2, 2020
(86) PCT No.: PCT/JP2020/025971

§ 371 Date: Jul. 13, 2021

(30) Foreign Application Priority Data
Jul. 3, 2019 (JP) 2019-124165

(51) Int. Cl. B26B 9/00; B26B 3/02

(52) U.S. Cl. CPC B26B 9/00; B26B 3/02

(57) ABSTRACT

A kitchen knife (1) includes a blade (3). The blade (3) is formed of a material having a density of 12.9 g/cc or more and a Young's modulus of 345 GPa or more.

### TECHNICAL FIELD

The present invention relates to kitchen knives and blades.

### BACKGROUND ART

Steel kitchen knives are widely used in places such as private homes, restaurants, and cafeterias (see, for example, PTL 1). Steel kitchen knives are advantageous in that they are relatively easy to fabricate and are inexpensive.

In contrast to steel kitchen knives, PTL 2 discloses a ceramic kitchen knife with high hardness and high corrosion resistance. Among ceramic kitchen knives, partially stabilized zirconia ceramic kitchen knives are known as kitchen knives with high strength and high toughness.

In addition, PTL 3 discloses the following kitchen knife. Specifically, PTL 3 discloses a kitchen knife having a blade including a base portion and a cutting edge portion. This kitchen knife is characterized in that the base portion contains a first metal, and the cutting edge portion contains a second metal and hard particles having a higher hardness than the second metal.

In addition, PTL 4 discloses the following kitchen knife. Specifically, PTL 4 discloses a kitchen knife having a supersteel alloy cutting member bonded to the lower portion of a blade over the entire length.

### CITATION LIST

### Patent Literature

PTL 1: Japanese Unexamined Patent Application Publication No. 2016-49314
PTL 2: Japanese Unexamined Patent Application Publication No. 2014-100179
PTL 3: International Publication No. 2016/208646
PTL 4: Japanese Unexamined Utility Model Registration Application Publication No. 64-1671

### SUMMARY OF INVENTION

### Technical Problem

Although such various non-steel kitchen knives are disclosed, they do not necessarily have satisfactory performance in terms of cutting quality and handleability, and a novel kitchen knife has been desired.

The present invention has been made in view of the foregoing background. An object of the present invention is to provide a kitchen knife with good handleability and cutting quality. The present invention can be practiced in the following embodiments.

### Solution to Problem

(1) A kitchen knife including a blade,

wherein the blade is formed of:

a material having a density of 12.9 g/cc or more and a Young's modulus of 345 GPa or more.

(2) The kitchen knife according to (1), wherein the material has a Rockwell hardness of HRA 81 or more.

(3) The kitchen knife according to (1) or (2), wherein the blade includes a cutting edge having an arithmetic mean roughness Ra of 0.5 μm or more and 20 μm or less in an orthogonal projection on a virtual plane perpendicular to a thickness direction of the blade.

(4) The kitchen knife according to any one of (1) to (3), wherein the material is a cemented carbide containing tungsten carbide crystal grains.

(5) The kitchen knife according to (4), wherein the tungsten carbide crystal grains have an average grain size of 0.4 μm or more and 1.5 μm or less.

(6) The kitchen knife according to (4) or (5), wherein the cemented carbide contains a Ni-based alloy as a binder phase.

(7) A blade formed of a material having a density of 12.9 g/cc or more and a Young's modulus of 345 GPa or more.

### Advantageous Effects of Invention

Because the blade is formed of a material having a specific gravity of 12.9 g/cc or more, the self-weight of the kitchen knife is effectively utilized, thus improving the handleability and the cutting quality. In addition, because the blade is formed of a material having a Young's modulus of 345 GPa or more, the deformation of the cutting edge during use is reduced, and the transmission of the force of the hand to the cutting edge is thereby facilitated, thus improving the handleability and the cutting quality.

If the material has a Rockwell hardness of HRA 81 or more, the cutting quality of the kitchen knife lasts for a long period of time.

If the blade includes a cutting edge having an arithmetic mean roughness Ra of 0.5 μm or more and 20 μm or less in an orthogonal projection on a virtual plane perpendicular to the thickness direction of the blade, the cutting edge is finely serrated, and the cutting quality of the kitchen knife is improved.

If the material is a cemented carbide containing tungsten carbide crystal grains, the deterioration of the blade is inhibited, and the cutting quality of the kitchen knife lasts for a long period of time.

If the cemented carbide contains tungsten carbide crystal grains, and the tungsten carbide crystal grains have an average grain size of 0.4 μm or more and 1.5 μm or less, the cutting quality of the kitchen knife is further improved.

If the cemented carbide contains a Ni-based alloy as a binder phase, it has high corrosion resistance to acids and alkalis, and the cutting quality of the kitchen knife lasts for a longer period of time.

### BRIEF DESCRIPTION OF DRAWINGS

FIG. 1 is a plan view of an example of a kitchen knife.

FIG. 2 is an illustration of a test method for kitchen knives (Experiment 1).

FIG. 3 is an illustration of a test method for kitchen knives (Experiments 2 to 5).

### DESCRIPTION OF EMBODIMENTS

The present invention will hereinafter be described in detail. In the present specification, the recitation of numerical ranges using “to” is intended to include lower and upper limits unless otherwise specified. For example, the recitation of “10 to 20” is intended to include both the lower limit “10” and the upper limit “20”. That is, “10 to 20” has the same meaning as “10 or more and 20 or less”.

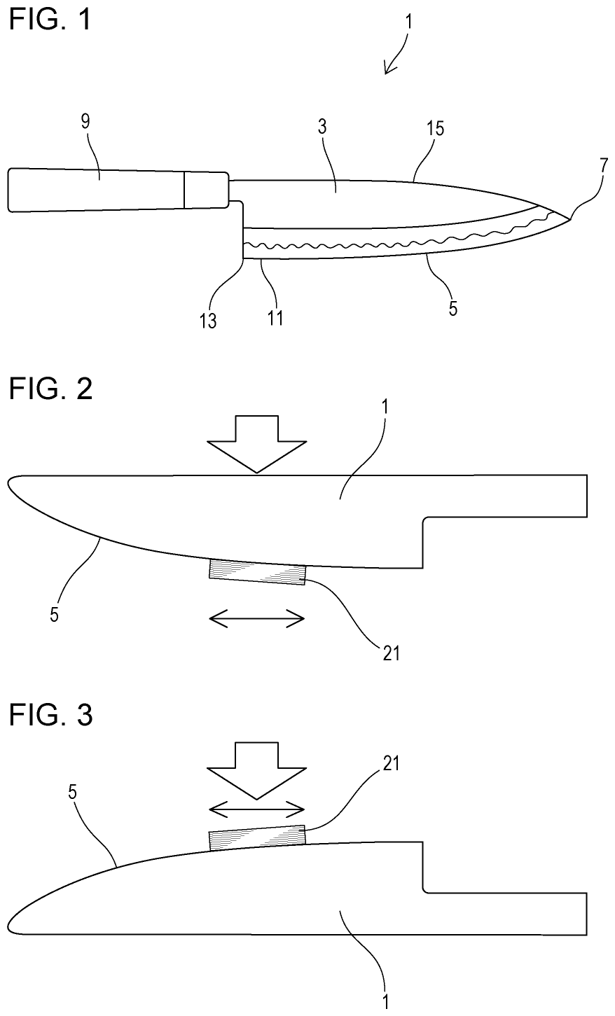

A kitchen knife 1 includes a blade 3 (see FIG. 1). The blade 3 is formed of a material having a density of 12.9 g/cc or more and a Young's modulus of 345 GPa or more.

The blade 3 includes a cutting edge 5 having an edge. A leading end portion of the cutting edge 5 serves as a point 7 that is used, for example, when a thin cooking ingredient or other material is cut into small pieces. A portion of the cutting edge 5 near a handle 9 serves as a heel 11 that is used in delicate procedures such as peeling. An endpoint portion of the cutting edge 5 located on the handle 9 side of the heel 11 serves as a chin 13 that is used for purposes such as removing potato eyes.

A back portion of the kitchen knife 1, that is, a back portion of the blade 3, serves as a spine 15 that is used not only as a position to be pressed by hand, but also for other purposes such as removing scales.

To improve the handleability and the cutting quality by effectively utilizing the self-weight of the kitchen knife 1, the material for the blade 3 preferably has a density of 12.9 g/cc or more, more preferably 13.6 g/cc or more, even more preferably 13.9 g/cc or more. On the other hand, the material for the blade 3 typically has a density of 19.0 g/cc or less, preferably 14.9 g/cc or less. In view of these, the material for the blade 3 preferably has a density of 12.9 g/cc or more and 19.0 g/cc or less, more preferably 13.6 g/cc or more and 14.9 g/cc or less, even more preferably 13.9 g/cc or more and 14.9 g/cc or less.

The density of the material is a value measured by Archimedes' method.

To improve the handleability and the cutting quality by reducing the deformation of the cutting edge 5 during the use of the kitchen knife 1 and thereby facilitating the transmission of the force of the hand to the cutting edge 5, the material for the blade 3 preferably has a Young's modulus of 345 GPa or more, more preferably 460 GPa or more, even more preferably 520 GPa or more. On the other hand, the material for the blade 3 typically has a Young's modulus of 714 GPa or less, preferably 610 GPa or less. In view of these, the material for the blade 3 preferably has a Young's modulus of 345 GPa or more and 714 GPa or less, more preferably 460 GPa or more and 610 GPa or less, even more preferably 520 GPa or more and 610 GPa or less.

The Young's modulus is measured as follows.

If the material for the blade 3 is a metal material, the Young's modulus refers to a value measured by a test method for Young's modulus of metal materials at elevated temperature as defined in JIS Z 2280, more specifically, a value measured by the ultrasonic pulse method. In the ultrasonic pulse method, the dynamic elastic modulus is measured based on the velocity at which ultrasonic pulses propagate through a test specimen.

If the material for the blade 3 is a ceramic material, the Young's modulus refers to a value measured by a test method for elastic modulus as defined in JIS R 1602, more specifically, a value measured by the ultrasonic pulse method. In the ultrasonic pulse method, the dynamic elastic modulus is measured based on the velocity at which ultrasonic pulses propagate through a test specimen.

A specific method for measuring the Young's modulus will be described below. A longitudinal wave vibrator and a transverse wave vibrator are used on the blade 3 to measure the longitudinal wave velocity V_{I} (unit: m/s) and the transverse wave velocity V_{S} (unit: m/s) from the propagation velocity of pulses. It is desirable to perform the measurement on a relatively thick portion of the blade 3, for example, on a portion near the spine 15 or a portion corresponding to the handle 9. The measurement is performed, for example, using a MODEL 25L high-precision ultrasonic thickness gauge manufactured by Panametrics Japan Co., Ltd. The elastic modulus is calculated from the measured values by the following equation, where p is the density (unit: kg/m³) of the blade 3.

$$E = {V}_{s}^{2} ρ \frac{3 {V}_{1}^{2} - 4 {V}_{s}^{2}}{{V}_{1}^{2} - {V}_{s}^{2}} \qquad [ Math . 1 ]$$

The measurement may be performed on a test specimen cut to a diameter of 10 mm (or 10 mm square) and a thickness of 1 to 3 mm from a relatively thick portion of the blade 3, for example, from a portion near the spine 15 or a portion corresponding to the handle 9. It should be understood that there is no limitation to the size of the test specimen as long as its elastic modulus can be measured.

To ensure that the cutting quality of the kitchen knife lasts for a long period of time, the material for the blade 3 preferably has a Rockwell hardness of HRA 81 or more, more preferably HRA 84 or more, even more preferably HRA 85.5 or more. On the other hand, the material for the blade 3 typically has a Rockwell hardness of HRA 95 or less. In view of these, the material for the blade 3 preferably has a Rockwell hardness of HRA 81 or more and HRA 95 or less, more preferably HRA 84 or more and HRA 95 or less, even more preferably HRA 85.5 or more and HRA 95 or less.

The Rockwell hardness is a value measured by a test method for Rockwell hardness testing as defined in JIS Z 2245.

A specific method for measuring the Rockwell hardness will be described below. A diamond indenter having a tip with a radius of curvature of 0.2 mm and a conical angle of 120° is pressed into the blade 3. The indenter is first set on a specimen at an initial test force of 98 N (10 kgf) and is then pressed at a test force of 1,471 N (150 kgf), and the test force is released again to an initial test force of 98 N (10 kgf). The difference h (unit: mm) between the depth of impression measured when the initial test force is first applied and the depth of impression measured when the test force is finally released to the initial test force is determined. It is desirable to perform the measurement on a relatively thick portion of the blade 3, for example, on a portion near the spine 15 or a portion corresponding to the handle 9. The measurement is performed, for example, using a Matsuzawa Seiki DTR-FA.

The Rockwell hardness can be determined as HRA=100−(h/0.002).

The measurement may be performed on a test specimen cut to a diameter of 10 mm (or 10 mm square) and a thickness of 1 to 3 mm from a relatively thick portion of the blade 3, for example, from a portion near the spine 15 or a portion corresponding to the handle 9. It should be understood that there is no limitation to the size of the test specimen as long as its Rockwell hardness can be measured.

To further improve the cutting quality of the kitchen knife 1, the cutting edge 5 of the blade 3 preferably has an arithmetic mean roughness Ra of 0.5 μm or more and 20 μm or less, more preferably 1.0 μm or more and 10 μm or less, in an orthogonal projection on a virtual plane perpendicular to the thickness direction of the blade 3.

More specifically, the arithmetic mean roughness Ra is measured as follows. An image of the cutting edge 5 of the blade 3 is first captured under a digital microscope at 300× magnification in the lateral direction of the blade 3. The captured image data is then loaded into image analysis software. Winroof manufactured by Mitani Corporation can be used as the image analysis software. An image of a region with a length of 300 μm in the longitudinal direction of the cutting edge 5 is loaded, and the arithmetic mean roughness Ra is calculated from data about the profile of the cutting edge 5. This is performed at five different positions of the cutting edge 5, and the average thereof is used as the arithmetic mean roughness Ra of the cutting edge 5.

The material for the blade 3 is preferably a cemented carbide or tungsten (W). An example of a suitable cemented carbide is a cemented carbide containing tungsten carbide crystal grains (hereinafter also referred to as “tungsten carbide (WC)-based cemented carbide”).

Examples of tungsten carbide-based cemented carbides include WC—Ni—Cr-based cemented carbides, WC—Co-based cemented carbides, and WC—Co—Cr-based cemented carbides.

The amount of binder phase (metal binder phase) present in the tungsten carbide-based cemented carbide is not particularly limited. To achieve a higher chipping resistance, the binder phase is preferably present in an amount of 8% by volume to 40% by volume based on 100% by volume of the total tungsten carbide-based cemented carbide. As used herein, “binder phase” refers to “Ni—Cr” for WC—Ni—Cr-based cemented carbides, “Co” for WC—Co-based cemented carbides, and “Co—Cr” for WC—Co—Cr-based cemented carbides.

In the case of WC—Ni—Cr-based cemented carbides, the binder phase is preferably a Ni-based alloy, which has high corrosion resistance to acids and alkalis and thus ensures that the cutting quality of the kitchen knife 1 lasts for a longer period of time. Specifically, “Ni” is preferably present in an amount of more than 50% by volume based on 100% by volume of “Ni—Cr” serving as “binder phase”. Furthermore, “Cr” is preferably present in an amount of 1% by volume to 10% by volume based on 100% by volume of “Ni—Cr” serving as “binder phase”, with the balance being “Ni”.

To improve the cutting quality of the kitchen knife 1, the average grain size of the tungsten carbide crystal grains in the tungsten carbide-based cemented carbide is preferably, but not limited to, 0.4 μm or more and 1.5 μm or less, more preferably 0.7 μm or more and 1.1 μm or less.

The average grain size (average crystal grain size) is determined by subjecting a cross-section of the material to mirror polishing and then plasma etching, observing the cross-section under a scanning electron microscope (SEM), and calculating the average grain size of the individual crystal grains using the intercept method.

Specifically, examples of suitable cemented carbides for use as the material for the blade 3 include “V30”, “V40”, “V50”, “V60”, “V70”, and “V80” in CIS (Japan Cemented Carbide Tool Manufacturer's Association Standards) 019D-2005.

### Examples

A more specific description will be given below with reference to the following examples. In tables, numbers marked with “*”, such as “1*”, indicate comparative examples.

### 1. Experiment 1

### (1) Fabrication of Kitchen Knives 1

Kitchen knives 1 including blades 3 formed of the various materials listed in Table 1 were fabricated. The Remarks column of Table 1 shows the compositions and grades of the materials. The physical properties (density and Young's modulus) of the materials shown herein are values measured by the methods described above.

TABLE 1

| Experimental | | | Density | Young's modulus | Handle- | Cutting | Comprehensive |
|---|---|---|---|---|---|---|---|
| Example | Material | Remarks | (g/cc) | (GPa) | ability | quality | evaluation |
| 1* | Titanium alloy | Ti—6Al—4V | 4.4 | 100 | 2 | 3 | 5 |
| 2* | Ceramic | ZrO2 | 6.0 | 200 | 2 | 3 | 5 |
| 3* | Stainless steel | SUS440C | 7.8 | 210 | 3 | 2 | 5 |
| 4* | Carbon steel | SK-85 | 7.8 | 210 | 3 | 3 | 6 |
| 5* | Molybdenum- | — | 7.8 | 210 | 3 | 3 | 6 |
| | vanadium steel | | | | | | |
| 6* | Cobalt steel | Cobalt- | 8.3 | 225 | 3 | 3 | 6 |
| | | chromium alloy | | | | | |
| 7* | Molybdenum | Mo | 10.3 | 324 | 3 | 4 | 7 |
| 8 | Cemented carbide | V80 | 12.9 | 460 | 4 | 5 | 9 |
| 9 | Cemented carbide | V30 | 14.9 | 610 | 5 | 5 | 10 |
| 10 | Tungsten | W | 19.0 | 345 | 4 | 4 | 8 |

### (2) Test Methods (Evaluation Methods) for Kitchen Knives 1

### (2.1) Test Method for Cutting Quality

A paper bundle 21 composed of a stack of sheets of paper, equivalent to newspaper, that had a width of 7.5 mm was used as the material subjected to cutting.

As shown in FIG. 2, each kitchen knife 1 was fixed, with the cutting edge 5 facing downward.

The paper bundle 21 was moved back and forth in the longitudinal direction of the cutting edge 5 while being in contact with the cutting edge 5 (see the double-headed arrow in FIG. 2). The paper bundle 21 traveled 20 mm in one-way motion (40 mm in back-and-forth motion).

The load acting from the cutting edge 5 on the paper bundle 21 during the back-and-forth motion was adjusted to about 750 g. In FIG. 2, the load acting from the cutting edge 5 on the paper bundle 21 is conceptually indicated by the blank arrow. The total load including the weight of the kitchen knife 1 was adjusted to about 750 g.

One back-and-forth motion of the paper bundle 21 was counted as one cutting operation. The number of completely cut sheets of paper were counted after each cutting operation.

In Experiment 1, the cutting quality of the kitchen knives 1 was evaluated from the number of cut sheets after 100 cutting operations.

Evaluation scores ranged from 1 to 5 as follows:

Score 1: 60 or less cut sheets

Score 2: 61 to 80 cut sheets

Score 3: 81 to 100 cut sheets

Score 4: 101 to 120 cut sheets

Score 5: 121 or more cut sheets

(2.2) Test Method for Handleability

Five subjects cut white radishes with the kitchen knives 1 and evaluated handleability on the following three-level scale:

Score 1: poor handleability

Score 2: normal handleability

Score 3: good handleability

### (2.3) Comprehensive Evaluation of Kitchen Knives 1

The score of the cutting quality test and the score of the handleability test were added together, and the total score was used to perform the comprehensive evaluation of the kitchen knives 1.

### (3) Evaluation Results of Kitchen Knives 1

The evaluation results are listed together in Table 1.

Experimental Examples 1 to 7 did not satisfy at least one of the following requirements (a) and (b).

Experimental Examples 8, 9, and 10 satisfied all of the following requirements (a) and (b).
Requirement (a): The material for the blade has a density of 12.9 g/cc or more.
Requirement (b): The material for the blade has a Young's modulus of 345 GPa or more.

All of Experimental Examples 8, 9, and 10, which satisfied all of the requirements (a) and (b), had a comprehensive evaluation score of 8 or higher, demonstrating that the handleability and the cutting quality were high. In contrast, all of Experimental Examples 1 to 7, which did not satisfy at least one of the requirements (a) and (b), had a comprehensive evaluation score of 7 or lower, demonstrating that at least one of the handleability and the cutting quality was low.

### 2. Experiment 2

### (1) Fabrication of Kitchen Knives 1

Kitchen knives 1 including blades 3 formed of the various materials listed in Table 2 were fabricated. The Remarks column of Table 2 shows the compositions and grades of the materials. The physical properties (density, Young's modulus, and HRA) of the materials shown herein are values measured by the methods described above.

### [Table 2]

TABLE 2

| | | | | | | Cutting quality | |
|---|---|---|---|---|---|---|---|
| Experimental | | | Density | | Young's modulus | Initial | End |
| example | Material | Remarks | (g/cc) | HRA | (GPa) | stage | stage |
| 11* | Carbon steel | SK-85 | 7.8 | 60 | 210 | 3 | 2 |
| 12 | Tungsten | W | 19.0 | 72.0 | 345 | 4 | 3 |
| 13 | Cemented carbide | V80 | 12.9 | 81.0 | 460 | 4 | 4 |
| 14 | Cemented carbide | V70 | 13.6 | 84.0 | 500 | 5 | 4 |
| 15 | Cemented carbide | V60 | 13.9 | 85.5 | 520 | 5 | 5 |
| 16 | Cemented carbide | V50 | 14.2 | 87.2 | 550 | 5 | 5 |
| 17 | Cemented carbide | V40 | 14.5 | 89.0 | 570 | 5 | 5 |
| 18 | Cemented carbide | V30 | 14.9 | 95.0 | 610 | 5 | 5 |

### (2) Test Method (Evaluation Method) for Kitchen Knives 1

In Experiment 2, a cutting quality test was performed.

A paper bundle 21 composed of a stack of sheets of paper, equivalent to newspaper, that had a width of 7.5 mm was used as the material subjected to cutting.

As shown in FIG. 3, each kitchen knife 1 was fixed, with the cutting edge 5 facing upward.

The paper bundle 21 was moved back and forth in the longitudinal direction of the cutting edge 5 while being in contact with the cutting edge 5 (see the double-headed arrow in FIG. 3). The paper bundle 21 traveled 20 mm in one-way motion (40 mm in back-and-forth motion).

The load acting from the cutting edge 5 on the paper bundle 21 during the back-and-forth motion was adjusted to about 750 g. In FIG. 3, the load acting from the cutting edge 5 on the paper bundle 21 is conceptually indicated by the blank arrow. The total load including the weight of the kitchen knife 1 was adjusted to about 750 g.

One back-and-forth motion of the paper bundle 21 was counted as one cutting operation. The number of completely cut sheets of paper were counted after each cutting operation.

In Experiment 2, the cutting quality of the kitchen knives 1 at the initial stage was evaluated from the number of cut sheets after 100 cutting operations, and the cutting quality of the kitchen knives 1 at the end stage was evaluated from the number of cut sheets after 300 cutting operations.

Evaluation scores ranged from 1 to 5 as follows:

Score 1: 60 or less cut sheets

Score 2: 61 to 80 cut sheets

Score 3: 81 to 100 cut sheets

Score 4: 101 to 120 cut sheets

Score 5: 121 or more cut sheets

### (3) Evaluation Results of Kitchen Knives 1

The evaluation results are listed together in Table 2.

Experimental Example 12 satisfied the following requirements (a) and (b), but did not satisfy the following requirement (c).

Experimental Examples 13, 14, 15, 16, 17, and 18 satisfied all of the following requirements (a), (b), and (c).
Requirement (a): The material for the blade has a density of 12.9 g/cc or more.
Requirement (b): The material for the blade has a Young's modulus of 345 GPa or more.
Requirement (c): The material for the blade has a Rockwell hardness of HRA 81 or more.

Experimental Examples 13, 14, 15, 16, 17, and 18, which satisfied the requirement (c), had a high evaluation score, i.e., “4”, for cutting quality at the initial stage, and also had an evaluation score of “4” or higher for cutting quality at the end stage, demonstrating that the cutting quality lasted.

In contrast, Experimental Example 12, which did not satisfy the requirement (c), had a high evaluation score, i.e., “4”, for cutting quality at the initial stage, but had an evaluation score of “3” for cutting quality at the end stage, demonstrating that the cutting quality decreased.

### 3. Experiment 3

### (1) Fabrication of Kitchen Knives 1

Kitchen knives 1 including blades 3 formed of the various materials listed in Table 3 were fabricated. The Remarks column of Table 3 shows the compositions and grades of the materials. The physical properties (Ra) of the materials shown herein are values measured by the method described above.

TABLE 3

| Experimental | | | Ra | Cutting |
|---|---|---|---|---|
| example | Material | Remarks | (μm) | quality |
| 19* | Carbon | SK-85 | 1.5 | 3 |
| | steel | | | |
| 20 | Cemented | V50 | 0.1 | 3 |
| | carbide | | | |
| 21 | Cemented | V50 | 0.5 | 4 |
| | carbide | | | |
| 22 | Cemented | V50 | 1.0 | 5 |
| | carbide | | | |
| 23 | Cemented | V50 | 5 | 5 |
| | carbide | | | |
| 24 | Cemented | V50 | 10 | 5 |
| | carbide | | | |
| 25 | Cemented | V50 | 20 | 4 |
| | carbide | | | |
| 26 | Cemented | V50 | 50 | 3 |
| | carbide | | | |

### (2) Test Method (Evaluation Method) for Kitchen Knives 1

In Experiment 3, a cutting quality test was performed.

A paper bundle 21 composed of a stack of sheets of paper, equivalent to newspaper, that had a width of 7.5 mm was used as the material subjected to cutting.

As shown in FIG. 3, each kitchen knife 1 was fixed, with the cutting edge 5 facing upward.

The paper bundle 21 was moved back and forth in the longitudinal direction of the cutting edge 5 while being in contact with the cutting edge 5 (see the double-headed arrow in FIG. 3). The paper bundle 21 traveled 20 mm in one-way motion (40 mm in back-and-forth motion).

The load acting from the cutting edge 5 on the paper bundle 21 during the back-and-forth motion was adjusted to about 750 g. In FIG. 3, the load acting from the cutting edge 5 on the paper bundle 21 is conceptually indicated by the blank arrow. The total load including the weight of the kitchen knife 1 was adjusted to about 750 g.

One back-and-forth motion of the paper bundle 21 was counted as one cutting operation. The number of completely cut sheets of paper were counted after each cutting operation.

In Experiment 3, the cutting quality of the kitchen knives 1 was evaluated from the number of cut sheets after 50 cutting operations.

Evaluation scores ranged from 1 to 5 as follows:

Score 1: 100 or less cut sheets

Score 2: 101 to 120 cut sheets

Score 3: 121 to 140 cut sheets

Score 4: 141 to 160 cut sheets

Score 5: 161 or more cut sheets

### (3) Evaluation Results of Kitchen Knives 1

The evaluation results are listed together in Table 3. Whether the individual requirements were satisfied or not in Experiment 3 will be described. Although the following requirements (a), (b), and (c) are not shown in Table 3, whether these requirements were satisfied or not was as follows.

Experimental Example 19, in which the material was the same as those in Experimental Example 4 (Table 1) and Experimental Example 11 (Table 2), did not satisfy any of the following requirements (a), (b), and (c).

Experimental Examples 21, 22, 23, 24, and 25 satisfied all of the following requirements (a), (b), (c), and (d).

Experimental Examples 20 and 26 satisfied the following requirements (a), (b), and (c), but did not satisfy the requirement (d).
Requirement (a): The material for the blade has a density of 12.9 g/cc or more.
Requirement (b): The material for the blade has a Young's modulus of 345 GPa or more.
Requirement (c): The material for the blade has a Rockwell hardness of HRA 81 or more.
Requirement (d): The cutting edge of the blade has an arithmetic mean roughness Ra of 0.5 μm or more and 20 μm or less.

Experimental Examples 21, 22, 23, 24, and 25, which satisfied the requirement (d), had an evaluation score of “4” or higher, demonstrating that the cutting edge was finely serrated, and the kitchen knives 1 had high cutting quality. Experimental Examples 22, 23, and 24 had an evaluation score of “5”, demonstrating that the kitchen knives 1 had particularly high cutting quality.

In contrast, Experimental Examples 20 and 26, which did not satisfy the requirement (d), had an evaluation score of “3”, demonstrating that the kitchen knives 1 had slightly low cutting quality.

### 4. Experiment 4

### (1) Fabrication of Kitchen Knives 1

Kitchen knives 1 including blades 3 formed of the various materials listed in Table 4 were fabricated. The Remarks column of Table 4 shows the grades and binder phases of the materials. The physical properties (average grain size of tungsten carbide crystal grains) of the materials shown herein are values measured by the method described above.

TABLE 4

| | | | Average | | |
|---|---|---|---|---|---|
| | | | grain | | |
| | | | size of | Cutting quality | |
| | | | WC crystal | Before | After |
| Experimental | | | grains | being | being |
| example | Material | Remarks | (μm) | left | left |
| 27* | Carbon | SK-85 | — | 3 | 1 |
| | steel | | | | |
| 28 | Cemented | Binder | 0.1 | 3 | 3 |
| | carbide | phase: Co | | | |
| 29 | Cemented | Binder | 0.4 | 4 | 4 |
| | carbide | phase: Co | | | |
| 30 | Cemented | Binder | 0.5 | 4 | 4 |
| | carbide | phase: Co | | | |
| 31 | Cemented | Binder | 0.7 | 5 | 5 |
| | carbide | phase: Co | | | |
| 32 | Cemented | Binder | 1.1 | 5 | 5 |
| | carbide | phase: Co | | | |
| 33 | Cemented | Binder | 1.5 | 4 | 4 |
| | carbide | phase: Co | | | |
| 34 | Cemented | Binder | 3.5 | 3 | 3 |
| | carbide | phase: Co | | | |

### (2) Test Method (Evaluation Method) for Kitchen Knives 1

In Experiment 4, the cutting quality of the kitchen knives 1 was measured before and after being left in water. Before the kitchen knives 1 were left in water, the cutting quality was evaluated by the following method. Thereafter, the kitchen knives 1 were left in water for 24 hours, and the cutting quality was then evaluated by the following method as before being left.

The evaluation method for cutting quality will be described below.

A paper bundle 21 composed of a stack of sheets of paper, equivalent to newspaper, that had a width of 7.5 mm was used as the material subjected to cutting.

As shown in FIG. 3, each kitchen knife 1 was fixed, with the cutting edge 5 facing upward.

The paper bundle 21 was moved back and forth in the longitudinal direction of the cutting edge 5 while being in contact with the cutting edge 5 (see the double-headed arrow in FIG. 3). The paper bundle 21 traveled 20 mm in one-way motion (40 mm in back-and-forth motion).

The load acting from the cutting edge 5 on the paper bundle 21 during the back-and-forth motion was adjusted to about 750 g. In FIG. 3, the load acting from the cutting edge 5 on the paper bundle 21 is conceptually indicated by the blank arrow. The total load including the weight of the kitchen knife 1 was adjusted to about 750 g.

One back-and-forth motion of the paper bundle 21 was counted as one cutting operation. The number of completely cut sheets of paper were counted after each cutting operation.

In Experiment 4, the cutting quality of the kitchen knives 1 was evaluated from the number of cut sheets after 50 cutting operations.

Evaluation scores ranged from 1 to 5 as follows:

Score 1: 100 or less cut sheets

Score 2: 101 to 120 cut sheets

Score 3: 121 to 140 cut sheets

Score 4: 141 to 160 cut sheets

Score 5: 161 or more cut sheets

### (3) Evaluation Results of Kitchen Knives 1

The evaluation results are listed together in Table 4. Whether the individual requirements were satisfied or not in Experiment 4 will be described. Although the following requirements (a), (b), and (c) are not shown in Table 4, whether these requirements were satisfied or not was as follows.

Experimental Example 27, in which the material was the same as those in Experimental Example 4 (Table 1), Experimental Example 11 (Table 2), and Experimental Example 19 (Table 3), did not satisfy any of the following requirements (a), (b), and (c).

Experimental Examples 29, 30, 31, 32, and 33 satisfied all of the following requirements (a), (b), (c), and (e).

Experimental Examples 28 and 34 satisfied the following requirements (a), (b), and (c), but did not satisfy the requirement (e).
Requirement (a): The material for the blade has a density of 12.9 g/cc or more.
Requirement (b): The material for the blade has a Young's modulus of 345 GPa or more.
Requirement (c): The material for the blade has a Rockwell hardness of HRA 81 or more.
Requirement (e): The tungsten carbide crystal grains have an average grain size of 0.4 μm or more and 1.5 μm or less.

In contrast to Experimental Examples 28 and 34, which did not satisfy the requirement (e), Experimental Examples 29, 30, 31, 32, and 33, which satisfied the requirement (e), had an evaluation score of “4” or higher before and after being left in water, demonstrating that the cutting quality was high. Experimental Examples 31 and 32, in which the tungsten carbide crystal grains had an average grain size of 0.7 μm or more and 1.1 μm or less, had an evaluation score of “5” or higher before and after being left in water for 24 hours, demonstrating that the cutting quality was particularly high.

### 5. Experiment 5

### (1) Fabrication of Kitchen Knives 1

Kitchen knives 1 including blades 3 formed of the various materials listed in Table 5 were fabricated. The Remarks column of Table 5 shows the grades and binder phases of the materials.

TABLE 5

| | | | Cutting quality | | |
|---|---|---|---|---|---|
| | | | Before | | |
| Experimental | | | being | | |
| example | Material | Remarks | left | 48 hr | 72 hr |
| 35* | Carbon | SK-85 | 3 | — | — |
| | steel | | | | |
| 36* | Stainless | SUS440C | 3 | 1 | 1 |
| | steel | | | | |
| 37 | Cemented | Binder phase: Co | 5 | 4 | 4 |
| | carbide | | | | |
| 38 | Cemented | Binder phase: Co—Cr | 5 | 5 | 4 |
| | carbide | | | | |
| 39 | Cemented | Binder phase: Ni—Cr | 5 | 5 | 5 |
| | carbide | | | | |

### (2) Test Method (Evaluation Method) for Kitchen Knives 1

In Experiment 5, the cutting quality of the kitchen knives 1 was measured before and after being left in salt water. Before the kitchen knives 1 were left in salt water, the cutting quality was evaluated by the following method. Thereafter, the kitchen knives 1 were left in salt water for 48 hours and 72 hours, and the cutting quality was then evaluated by the following method as before being left.

The evaluation method for cutting quality will be described below.

A paper bundle 21 composed of a stack of sheets of paper, equivalent to newspaper, that had a width of 7.5 mm was used as the material subjected to cutting.

As shown in FIG. 3, each kitchen knife 1 was fixed, with the cutting edge 5 facing upward.

The paper bundle 21 was moved back and forth in the longitudinal direction of the cutting edge 5 while being in contact with the cutting edge 5 (see the double-headed arrow in FIG. 3). The paper bundle 21 traveled 20 mm in one-way motion (40 mm in back-and-forth motion).

The load acting from the cutting edge 5 on the paper bundle 21 during the back-and-forth motion was adjusted to about 750 g. In FIG. 3, the load acting from the cutting edge 5 on the paper bundle 21 is conceptually indicated by the blank arrow. The total load including the weight of the kitchen knife 1 was adjusted to about 750 g.

One back-and-forth motion of the paper bundle 21 was counted as one cutting operation. The number of completely cut sheets of paper were counted after each cutting operation.

In Experiment 5, the cutting quality of the kitchen knives 1 was evaluated from the number of cut sheets after 50 cutting operations.

Evaluation scores ranged from 1 to 5 as follows:

Score 1: 100 or less cut sheets

Score 2: 101 to 120 cut sheets

Score 3: 121 to 140 cut sheets

Score 4: 141 to 160 cut sheets

Score 5: 161 or more cut sheets

### (3) Evaluation Results of Kitchen Knives 1

The evaluation results are listed together in Table 5.

Whether the individual requirements were satisfied or not in Experiment 5 will be described. Although the following requirements (a), (b), and (c) are not shown in Table 5, whether these requirements were satisfied or not was as follows.

Experimental Example 35, in which the material was the same as those in Experimental Example 4 (Table 1), Experimental Example 11 (Table 2), Experimental Example 19 (Table 3), and Experimental Example 27 (Table 4), did not satisfy any of the following requirements (a), (b), and (c).

Experimental Example 36, in which the material was the same as that in Experimental Example 3 (Table 1), did not satisfy any of the following requirements (a), (b), and (c).

Experimental Example 39 satisfied all of the following requirements (a), (b), (c), and (f).

Experimental Examples 37 and 38 satisfied the following requirements (a), (b), and (c), but did not satisfy the requirement (f).
Requirement (a): The material for the blade has a density of 12.9 g/cc or more.
Requirement (b): The material for the blade has a Young's modulus of 345 GPa or more.
Requirement (c): The material for the blade has a Rockwell hardness of HRA 81 or more.
Requirement (f): The cemented carbide contains a Ni-based alloy as a binder phase.

The evaluation scores of Experimental Examples 37 and 38, which did not satisfy the requirement (f), decreased from “5” to “4” after being left in salt water for 72 hours, demonstrating that the cutting quality decreased. In contrast, Experimental Example 39, which satisfied the requirement (f), had an evaluation score of “5” before and after being left in salt water for 72 hours, demonstrating that the cutting quality lasted.

### 6. Summary of Experimental Results

When the blade 3 was formed of a material having a specific gravity of 12.9 g/cc or more, the self-weight of the kitchen knives 1 was effectively utilized, thus improving the handleability and the cutting quality. In addition, when the blade 3 was formed of a material having a Young's modulus of 345 GPa or more, the deformation of the cutting edge during use was reduced, and the transmission of the force of the hand to the cutting edge was thereby facilitated, thus improving the handleability and the cutting quality.

When the material had a Rockwell hardness of HRA 81 or more, the cutting quality of the kitchen knives lasted.

When the cutting edge of the blade 3 had an arithmetic mean roughness Ra of 0.5 μm or more and 20 μm or less, the cutting edge was finely serrated, and the cutting quality of the kitchen knives was improved.

When the material was a cemented carbide containing tungsten carbide crystal grains, the deterioration of the blade was inhibited, and the cutting quality of the kitchen knives lasted for a long period of time.

When the cemented carbide contained tungsten carbide crystal grains, and the tungsten carbide crystal grains had an average grain size of 0.4 μm or more and 1.5 μm or less, the kitchen knives 1 had high cutting quality.

When the cemented carbide contained a Ni-based alloy as a binder phase, it had high corrosion resistance to chemicals, and the cutting quality of the kitchen knives 1 lasted for a longer period of time.

The present invention is not limited to the embodiment described in detail above, and various modifications and changes can be made within the scope of the invention as defined by the claims.

(1) Although an embodiment in which a member different from the blade 3 is provided as the handle 9 on the base end side of the spine 15 of the blade 3 has been described above, the handle 9 is not necessarily formed by the different member. For example, the base end side of the blade 3 may be processed so as to function as a handle for gripping by hand.

### REFERENCE SIGNS LIST

1 . . . kitchen knife
3 . . . blade
5 . . . cutting edge
7 . . . point
9 . . . handle
11 . . . heel
15 . . . spine
21 . . . paper bundle

What is claimed is:

1. A kitchen knife comprising a blade,
wherein the blade comprises:
a material having a density of 12.9 g/cc or more and a Young's modulus of 345 GPa or more.

2. The kitchen knife according to claim 1, wherein the material has a Rockwell hardness of HRA 81 or more.

3. The kitchen knife according to claim 1, wherein the blade includes a cutting edge having an arithmetic mean roughness Ra of 0.5 μm or more and 20 μm or less in an orthogonal projection on a virtual plane perpendicular to a thickness direction of the blade.

4. The kitchen knife according to claim 1, wherein the material is a cemented carbide containing tungsten carbide crystal grains.

5. The kitchen knife according to claim 4, wherein the tungsten carbide crystal grains have an average grain size of 0.4 μm or more and 1.5 μm or less.

6. The kitchen knife according to claim 4, wherein the cemented carbide contains a Ni-based alloy as a binder phase.

7. A blade comprising a material having a density of 12.9 g/cc or more and a Young's modulus of 345 GPa or more.
